(19) United States
(12) Patent Application Publication
(10) Pub. No.: US 2004/0148237 A1
(43) Pub. Date: Jul. 29, 2004

(54) Real time management of a communication network account

(75) Inventors: Ran Bittmann, Tel Aviv (IL); Konstantin Shteiman, Rishon-Lezion (IL); Rafael Kiel, Modiin (IL); Noa Gan, Moshav Beit-Oved (IL)

Correspondence Address: BROWDY AND NEIMARK, P.L.L.C., 624 Ninth Street, N.W., Washington, DC, 20001, US

(73) Assignee: mSAFE Ltd., Park Tamar, Rehovot (IL)

(21) Appl. No.: 10/353,064

(22) Filed: Jan. 29, 2003

(51) Int. Cl. G06F 17/60

(52) U.S. Cl. 705/35

(57) ABSTRACT

Provided are methods, systems and devices for real time management of a communication network account. A system according to a preferred embodiment includes: an activity monitoring unit installed in or connected to a communication device associated with the account, the unit configured to monitor data activity of the communication device and to report on the data activity; and an activity monitoring server utility configured to receive reports on the data activity from the unit, rate the data activity, and update at least one allowance of the account based on a result of the rating. Permitted activity for the account is changed if an allowance of the account reaches a predetermined restriction level.

### FIELD AND BACKGROUND OF THE INVENTION

The present invention relates to management of a communication network account.

A communication device transmits and receives (non-packetized) voice and/or data (“data” herein below including inter-alia packetized voice) via a communication network. Typically voice traffic can be mapped onto voice events such as calls. The rating of a voice event is typically based on rules related to the event (for example, the duration of the call, the distance between the two parties to the call, etc.) and/or related to the account (for example, the number of free minutes per period, discounts for multiple communication devices, etc).

The stream of data to and from the communication device typically can not be as easily rated. Rating data is difficult because data can be evaluated at different levels. For example at the traffic level, the number of bytes and/or packets can be counted and rated. As another example at the service level, the type of traffic can be determined and rated. As another example the transaction represented by the data can be rated. In addition, one or more communication lines with the communication device may always be open. Data therefore may be received and transmitted to and from the communication device continuously with related data possibly interspersed among unrelated data, increasing the difficulty of rating the data.

In the related art, International Publication Number WO 02/09408 A1 discloses a method and system for rating a data communication session between a network, and a wireless device. In an exemplary embodiment, the method monitors a series of events namely a setup event, a begin event and an end event, which take place during a communication session. The monitoring of such events is accomplished by a data rating application, which resides on the wireless device. By monitoring such events, the data rating application is then able to rate the communication session using a number of rating options. The rating option selected includes both how to meter the data transmitted during a data session and determine the rate to be applied to each metered increment.

The method and system disclosed in International Publication Number WO 02/09408 A1 requires a pre-definition of events for the data, which may or may not be optimal. Additionally, the monitoring unit on the wireless device is an independent unit. The monitoring unit is therefore essentially required to manage the account associated with the wireless device, which may be difficult if the monitoring unit is not aware of certain account aspects. Furthermore, such a method and system requires additional wireless device resources (for example additional memory to store rating tables, additional computing power to compute the rating, etc.) and there is a need to provide a way to allow updating of the rating tables stored in the device.

International Publication Number WO 02/17612 A2 discloses a method, system and device for monitoring activity of a client wireless communication device (WCD), communicating through a communication medium. A unit or device installed is as fitted onto said device monitors and records said activity and transmits it automatically, in a client non-controlled fashion, to an activity monitoring server utility.

The activity monitoring server utility of international Publication Number WO 02/17612 A2 manages the account associated with the WCD. That publication, however, does not teach real time restriction of account activity as part of the management.

### SUMMARY OF THE INVENTION

According to the present invention there is provided a method of real time management of a communication network account, comprising: an activity monitoring unit installed in or connected to a communication device monitoring data activity of the communication device, the communication device associated with the communication network account; the activity monitoring unit reporting on the monitored data activity to an activity monitoring server utility; the activity monitoring server utility rating the reported data activity; based on a result of the rating, the activity monitoring server utility updating at least one allowance of the account; and if an allowance of the account reaches a pre-determined restriction level, changing the permitted activity for the account. The change of the permitted activity can be immediate or delayed

The change may be a limit to a specific activity, e.g. in the case of a mobile phone permitting only incoming calls; or the change may involve barring all activity of the communication device until the account has some credit again. Even in the latter case, the communication device will typically maintain the ability to communicate at least with the back office in order to permit the user to update the account.

According to the present invention there is also provided a system for real time management of a communication network account, comprising: an activity monitoring unit installed in or connected to a communication device associated with the account, the unit configured to monitor data activity of the communication device and to report on the data activity; and an activity monitoring server utility configured to receive reports on the data activity from the unit and to rate the data activity, and configured to update at least one allowance of the account based on a result of the rating; wherein the permitted activity for the account is immediately changed if an allowance of the account reaches a predetermined restriction level.

According to the present invention there is further provided an activity monitoring unit installed in or connected to a communication device, for real time management of a communication network account associated with the communication device, comprising: a monitor for monitoring data activity of the communication device, and a report generator for generating reports on the data activity for use by an associated activity monitoring server utility

According to the present invention there is still further provided an activity monitoring server utility for real time management of a communication network account comprising: a mediation system for receiving reports on data activity from at least one monitoring unit installed in or connected to at least one communication device associated with the account; a rating system for rating the data activity; an allowance manager system for managing at least one allowance of the account; wherein the permitted activity for the account is changed immediately if an allowance of the account reaches a predetermined restriction level.

### BRIEF DESCRIPTION OF THE DRAWINGS

The invention is herein described, by way of example only, with reference to the accompanying drawings, wherein:

FIG. 1 is a block diagram of a system for real time management of a communication network account, according to a preferred embodiment;

FIG. 2 is a block diagram of an activity monitoring server utility, according to a preferred embodiment of the present invention;

FIG. 3A is a block diagram of a cellular telephone, according to a preferred embodiment of the present invention;

FIG. 3B is a block diagram of a cellular telephone, according to another preferred embodiment of the present invention;

FIG. 3C is a block diagram of a cellular telephone, according to another preferred embodiment of the present invention;

FIG. 4 is a block diagram of an activity monitoring unit, according to a preferred embodiment of the present invention;

FIG. 5 is flowchart of a method for real time management of a communication network account, according to a preferred embodiment of the present invention; and

FIG. 6 is a flowchart of a method for real time management of a communication network account, according to another preferred embodiment of the present invention.

### DESCRIPTION OF THE PREFERRED EMBODIMENTS

A preferred embodiment of the present invention allows real time management of a communication network account, including real time change in the permitted activity of the account when necessary.

The change in the permitted activity should be understood as meaning any change that will determine what can be done in the specific account. In one embodiment, the change in the permitted activity may be the total blocking of all communication until credit for the account is re-established. When this occurs, some limited communication, in particular communication with the central system is allowed, to replenish credit.

In accordance with the invention, the permitted activity of the account can allow limited use of the communication device, for example in the case of a mobile device receiving incoming calls; receiving only broadcast information; restricting use of the device only for specific use, e.g. voice, data; allowing communication only for emergency use.

In the following, the invention will be described with particular reference to an embodiment in which the change in the permitted activity is the restriction of the activity allowed for the account. The term “restriction activity” appearing below refers to this embodiment. It should be understood that this is an example only of the broader scope of said change in the permitted activity to which the invention is concerned with.

As will be appreciated, the implementation of the change of permitted activity can be immediate or delayed.

The principles and operation of a real time management of a communication network account according to the present invention may be better understood with reference to the drawings and the accompanying description. All examples given below are non-limiting illustrations of the invention described and defined herein.

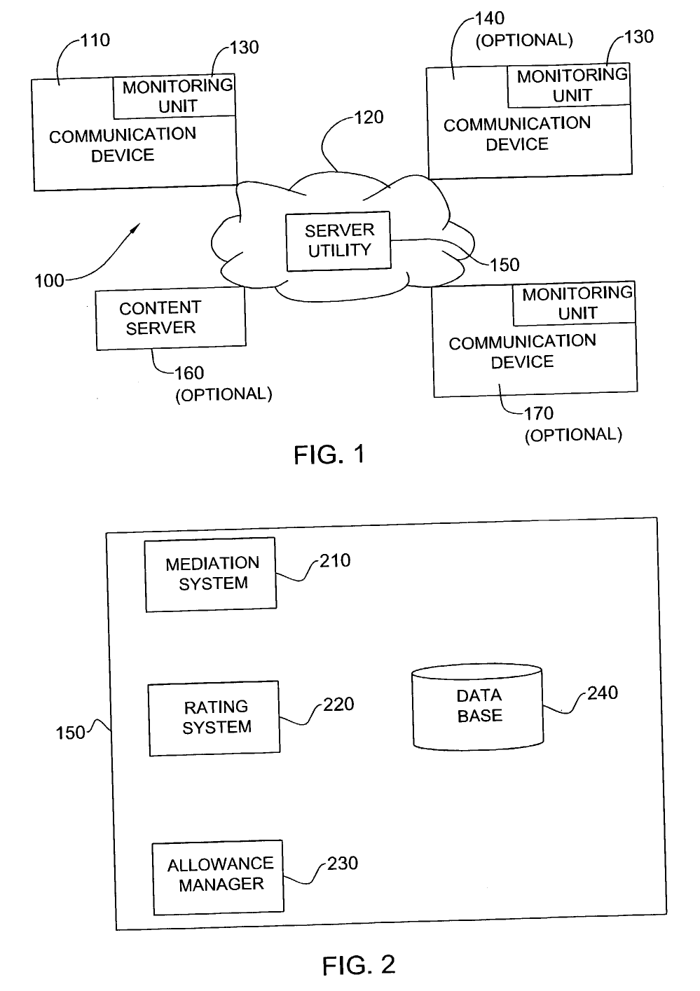

Referring now to the drawings, FIG. 1 illustrates a system 100 according to a preferred embodiment of the present invention. A communication device 110 connects to a communication network 120. An activity monitoring unit 130 may be installed within communication device 110 or may be connected thereto. Activity monitoring unit 130 monitors data activity of communication device 110.

An activity monitoring server utility 150 manages the account of communication device 110. Optionally, one or more other communication devices 140 are associated with the same account as communication device 110. Preferably, these communication devices 140 also include activity monitoring units 130 installed within or connected thereto

System 100 typically although not necessarily also includes one or more client communication devices 170 (associated with accounts other than the account of device 110) and/or one or more content servers 160 (such as web servers). Preferably, communication devices 170 include monitoring units installed within or connected thereto. Although in FIG. 1 content server 160 is shown outside of “cloud” 120 and server utility 150 is shown inside of cloud 120, in other embodiments one or more content servers 160 can be inside of cloud 120 and/or server utility 150 can be outside of cloud 120.

Referring now to monitoring unit 130, associated with device 110, in some embodiments this monitoring unit 130 monitors all data activity of device 110, while in other embodiments, some data activity of device 110 may not be monitored by monitoring unit 130. The monitored data activity includes some or all of the data transferred to and/or from device 110 over communication network 120, for example some or all data transferred between devices 110 and 140, some or all data transferred between devices 110 and 170, some or all data transferred between device 110 and content server 160, etc. The monitored data activity can also or instead include some or all of the data activity internal to device 110. Examples of the monitored data activity include inter-alia one or more of the following: web surfing, game-playing, emails, short message service (sms), voice over IP, faxing, transactions, etc. As the invention will be described below from the perspective of device 110 (and optionally 140), there will be no further discussion of device 170 and server 160.

Communication network 120 can be of any type including inter-alia cellular, PSTN, Internet, Intranet, a combination of any of the above technologies, etc. As an example of a combination, cellular telephone operators may provide a gateway, for example a Wireless Application Protocol (“WAP”) gateway, between the cellular telephone network and the Internet. As another example, access from the Internet to a cellular telephone network can be provided through a push proxy server.

Communication devices 110 and/or 140 can be of any type, including inter-alia wireless devices (cellular phones, pagers, etc.), Public Switched Telephone Network (PSTN) devices (fax machines, telephones, etc.), computers, Personal Digital Assistants (PDA's) etc, as appropriate to the applicable communication network 120. Communication device 110 and 140 associated with the same account may or may not be of the same type.

The communication infrastructure includes all components of communication network 120 that are involved in the provision of communication service to communication device 110 and/or 140 using the appropriate technology. For example in the case of a cellular telephone system, the communication infrastructure includes the base stations of the various cells, a cellular telephone switching office that has all the phone connections of the cellular communication devices that communicate with a base station that is linked to the cellular telephone switching office, central system that coordinates activity and supports central offices, etc. In case of a PSTN telephone system, the communication infrastructure includes the cabling, the central office switch, etc. In the case of the Internet, the communication infrastructure includes the backbone routers, access routers, name servers, end nodes, etc. With the evolution of telephone networks (initially cellular but also PSTN) to packet switching technology in the network backbone, an increase in the number of IP networking devices (e.g., routers) in corresponding communication networks 120 can be expected, along with increased billing challenges at least for data. If the communication is via a particular communication network 120 using a combination of technologies, the communication infrastructure includes components corresponding to the combination.

The communication infrastructure can be thought of as “belonging” to one or more network operators (either by ownership, rental, or other suitable arrangement). Examples of network operators include: cellular operators, PSTN operators, Internet service providers (ISPs), etc. Therefore in order to access the communication infrastructure, an account(s) associated with communication device 110 (and optionally 140) is established with the corresponding network operator(s). For example in order to access the Internet, an account may be required with both a PSTN operator and an ISP. Alternatively, account(s) established with one or more operators can also include debits/credits related to infrastructure belonging to third part(ies). For example an account with a local telephone operator may include long distance charges (for which the local operator reimburses the long distance operator). In the description below the term “account” should be understood to include either a single account or a plurality of accounts associated with communication device 110 (and optionally device(s) 140).

The account associated with communication device 110 (and optionally device 140) can be of any type, for example a prepaid account or an account where payment for balance due is due periodically (sometimes termed postpaid account). A postpaid account may have a credit line (i.e. credit limit) which limits the allowable balance due. In some cases, a particular account may be both prepaid and postpaid. For example communication device 110 associated with a parent may be postpaid (credit line) while communication device 140 associated with a child may be prepaid (prepaid balance). Billing and/or receiving payment for the balance due on an account and/or receiving prepayment of a balance for an account, can be made by any known method, including inter-alia sending a debit or credit note, electronic transfer from another account (for example a bank account), debiting or crediting another account (for example a credit card account), check, money order, cash, etc. In addition, settling of debits/credits with providers of goods or services to the account can also be made by any known method, for example the methods listed above. For example, if the account includes a debit for a purchase transaction of a product, the merchant is reimbursed for the transaction as part of the settling. As another example, if the account (for example with a local telephone operator) includes a debit for entry into communication infrastructure belonging to a third party operator (for example the long distance operator), the third party operator is reimbursed for the service as part of the settling.

In a preferred embodiment of the invention, one or more allowances are associated with each account. Although one or more of the account allowances may not have associated restriction level(s), preferably at least one of the allowances has at least one associated restriction level. When one or more of the allowances reaches the associated restriction level(s), activity in the account begins to be restricted (as will be explained below). It should be understood that an allowance in some instances may go beyond the associated restriction level before some or all activity restrictions set in, but in the context of the invention, the concept of restricting activity when an allowance reaches the predetermined restriction level should be understood to mean beginning to restrict activity when the restriction level has been reached and/or beginning to restrict activity after a time delay from when the restriction level has been reached (which in some instances may allow the level to also be overstepped).

In one embodiment, one or more of the allowances represents as an amount of money in a pre-defined currency. For example, an allowance of 500 may represent the (unused) remaining credit line or the (unused) remaining prepaid balance associated with a particular account in US dollars. As another example, an allowance of 500 may represent the used amount of the credit line (i.e. balance due) or the used amount of the prepaid balance in US dollars. In another embodiment, one or more of the allowances represents a quantity of past or future activity, for example volume in bytes, volume in packets, time units, number of accesses, number of downloads, number of uses, etc. For example an allowance of 500, may represent 500 Mbytes of data previously communicated to or from communication device 110 and/or 140 or 500 Mbytes of data which can be transferred in the future. As another example 500 can represent the number of web pages (of any type or of a specific type) accessed in a past time interval or the number of allowable web page accesses per a future time interval.

In one embodiment, server utility 150 allocates an allotment corresponding to each allowance or corresponding to each of a subset of the allowances to monitoring unit(s) 130 in order to facilitate the real time tracking of those allowances. For example, an allotment can range from zero up to the total corresponding allowance (for example in some cases where the allowance represents the unused balance, unused credit line, or quantity of allowable future activity) or from zero up to the difference between a pre-determined account limit and the corresponding allowance (for example in some cases where the allowance represents the used balance, used credit line, or quantity of past activity).

For ease of explanation, in the description below it is assumed that the allowance(s) and the allotment(s) are measures of allowable future activity (for example unused pre-paid balance, unused credit line or quantity of allowable future activity). However, the terms “allowance” and “allotment” should be understood in the context of the invention to also denote functions of measurable measures of, allowable future activity, for example total prepaid balance less unused prepaid balance (i.e. used prepaid balance), total credit line less unused credit line (i.e. used credit line), and total quantity of allowable activity less quantity of allowable future activity (i.e. quantity of past activity). If functions are denoted, similar methods to those described below may be used, mutatis mutandis.

Activity-monitoring server utility 150 may be any combination of hardware, software and/or firmware that performs the functions as defined and explained herein. There may be a single server utility 150 or multiple server utilities 150 which are either centralized or distributed. For example if there are multiple utilities 150, each monitoring unit 130 may be assigned to one of the utilities 150 and optionally to a second backup utility 150. Continuing with the example, the capacity of a particular server utility 150 may be calculated so that a correct number of monitoring units 130 is assigned to that server utility 150. Herein below the term “server utility” should be understood to include either a single server utility or multiple server utilities. Server utility 150 may be independent, or may be comprised within or integrated within the system of the network operator, for example in the internal network of the network operator. Server utility 150 may be linked for example to an independent network interface that communicates with all the activity monitoring units of the communication devices through the communication infrastructure, alternatively, the communication interface of server utility 150 may be integrated with the communication system infrastructure.

A preferred embodiment of server utility 150 is shown in FIG. 2. In the illustrated configuration, server utility 150 includes a mediation system 210 for receiving data activity reports from monitoring units (and optionally for receiving other reports of activity), and preferably if required correlating and/or aggregating reports from multiple sources to produce a unified report record. The unified report record is preferably formatted to a protocol known to a rating system 220. Server utility 150 also includes rating system 220 for rating the data activity reported by the monitoring units (and optionally for rating other activity), and an allowance manager system 230 for managing account allowances (including optionally the assigning of allotments to monitoring units). Rating system 220 and allowance manager system 230 preferably share access to a database 240 which stores account information. For example database 240 may be the customer database of the network operator, a replication of the customer database, or part of the customer database. Account information stored in database 240 can include for example inter-alia rates, discounts, subscription plan information (for example the frequency of pushed reports), allowances, etc. As may readily be appreciated by the artisan, the invention is not restricted to any specific system architecture for server utility 150, and any system having functions such as these defined and described above, and further below, is within the scope of the invention. For example, while server utility 150 is illustrated here as being comprised of several modules, in reality, while this may be the case, it is also possible to incorporate the illustrated modules into fewer or more modules.

Allowance manager 230 updates the allowance(s) for the account associated with communication device 110 (and optionally with device(s) 140) based on the rating of activity involving communication device 110 (and optionally communication device(s) 140). At a minimum, allowance manager 230 receives the results of rating performed by rating system 220 on data activity reported to mediation system 210 by monitoring unit 130 of device 110. Optionally, allowance manager 230 may also receive one or more of the following: results of rating performed by rating system 220 on data activity reported to mediation system 210 by one or more monitoring units 130 of device(s) 140, results of rating performed by rating system 220 on voice activity reported by system resources (for example probes, switches, legacy servers, etc.), results of rating performed by rating system 220 on data activity reported by system resources (for example probes, switches, VoIP servers, etc), and/or results of rating performed somewhere other than at server utility 150, for example in other billing systems such as those manufactured by Amdocs, Convergys or Portal.

Herein below the term “update” in the context of an allotment or allowance should be understood to include instances where no change is required to the previous value. For example when updating an allowance, more than one rating result may cancel one another out, thereby leaving the allowance unchanged from a previous value. As another example for when allotments are used, the rating results may confirm the corresponding allowance value (from which the allotment was already subtracted) and therefore updating the allowance for the rating result may consist of leaving the previous value of the allowance unchanged.

As mentioned above, if an allowance reaches a pre-determined restriction level, allowance manager 230 causes the restriction of activity in the account. Restriction continues until the allowance is replenished to a predetermined replenishment level. It should also be understood that in some cases the type(s) of restricted activity may have a direct connection with the allowance which reached the restriction level. For example, if an allowance represents the number of transmitted emails, then in some cases at the restriction level, only emails may be restricted. In other cases there may not be a direct connection between the type(s) of restricted activity and the allowance.

When the allowance reaches a restriction level (or in some cases after a time delay), data activity can begin to be restricted in one or more of the following ways inter-alia: First, in preferred embodiments including allotments, no allotment or no additional allotment may be allocated to monitoring unit(s) 130, or a smaller allotment may be allocated to monitoring unit(s) 130. By reducing the size of the allocation or not allocating at all, server utility 150 restricts data activity. It should be evident that the reduction in size of an allotment or non-allocation restricts data activity although a slowdown in data activity is not necessarily immediately implemented. Data activity may continue unchanged at communication device 110 and/or 140 if the associated monitoring unit(s) 130 still has a remaining allotment, for example in some cases when an additional allocation was requested at an allotment rechecking level not identical to the limiting level (as defined further below). Second, blockage of some or all data activity either by monitoring unit 130 (as described further below) or on the network end may occur.

For example, on the network end, switches and routers through which the data flows may perform network based blocking. In some cases multiple network switches and/or routers may need to be informed and act in a coordinated synchronized manner to block the data activity. In some other cases, traffic may be required to pass through a single network element to block the data activity. For example the single network point may be required to understand higher level protocols and/or the data traffic rates may be required to be low. Optionally, for improved efficiency of network blocking, some applications may need to be adjusted so that an abrupt closure of a connection with device 110 does not brake the application and/or an application does not wait unnecessarily for a time-out after the connection is abruptly closed.

Examples of blockage of some or all data activity include inter-alia: blockage of all data activity, blockage of certain types of data activity, blockage of non-free data activity, blockage of non-service related data activity (but allowing some or all service related data activity, for example data activity for replenishing the allowance), preventing all or some new data sessions from beginning (while allowing some or all current data sessions to complete), etc. As mentioned above, some or all restrictions on data activity sometimes begin to occur only after a time delay from when the restriction level is reached. For example, in some cases server utility 150 may recalculate the allowance once the restriction level has already been overstepped, only then realizing that the restriction level has been reached and causing the start of restrictions. As another example, a particular monitoring unit 130 may only request an additional allotment allocation when the restriction level has already been overstepped, and only then will receive a reduced allocation or be refused allocation.

As it is well known in the art, restriction of voice activity can be performed for example by the switches that are part of the voice network of communication network 150. For example, in cases when voice from communication device 110 travels through more than one switch, each of these switches may be allocated allotment(s) from the allowance(s) by server utility 150.

It should also be understood that in some cases there may be one restriction level for an allowance while in other cases there may be more than one restriction level for the same allowance. For example, at one restriction level, communication device 110 and/or 140 may not begin new data sessions while at a second restriction level, communication device 110 and/or 140 may block all data activity.

The replenishment level for example can be any amount above (one or more of) the restriction level(s) (or below as the case may be). As another example, the replenishment level can be an amount significantly above the (one or more) restriction level(s) (or below as the case may be), for example an amount equal to the average allowance required for a certain time period (for example a day, week or month) so as to reduce the frequency of replenishment. In some cases the user associated with the account must actively replenish the allowance (for example by fulfilling pre-determined conditions of replenishment) while in other cases the allowance is replenished automatically (for example if the network operator allows five free games per day, each day the allowance is automatically replenished), or through third party actions (for example if a web site owner allows 2 purchase transactions, the web site owner can later decide to allow 3 purchase transactions and the allowance will be changed accordingly). In the context of the invention, the “user” associated with account can be any user or group of users including inter-alia, an individual, a group of individuals, or an entity (company, organization, government, etc).

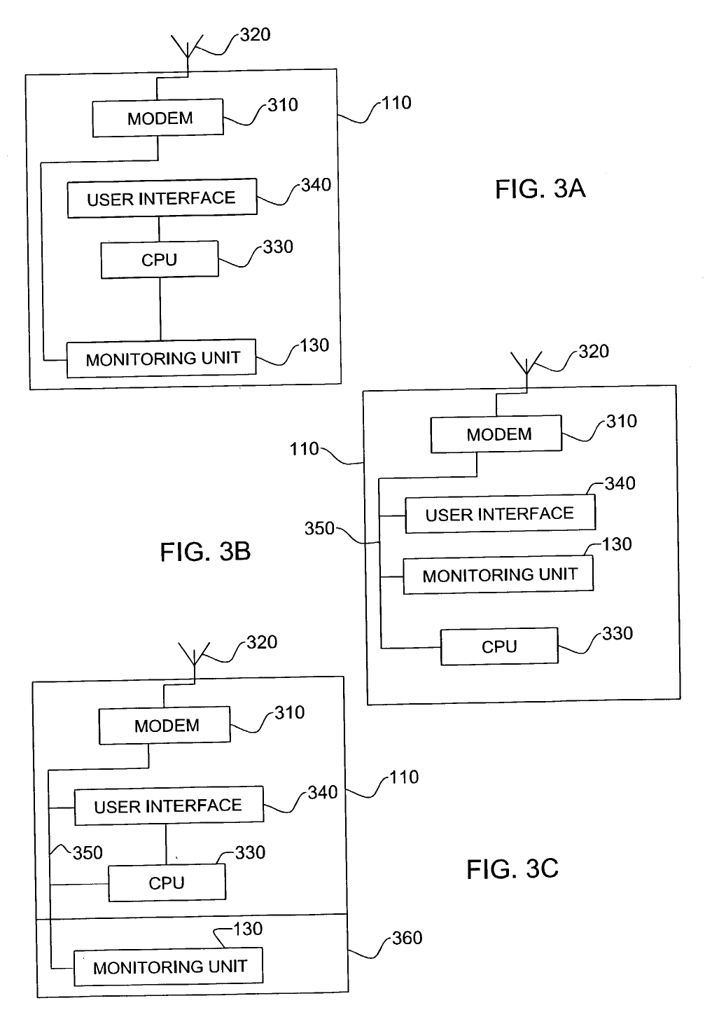

For the sake of illustration, FIGS. 3A and 3B show examples of preferred embodiments of communication device 110 with monitoring unit 130 installed within, and 3C shows an example of a preferred embodiment of communication device 110 with monitoring unit 130 connected thereto, where in these examples communication device 110 is assumed to be a cellular telephone. FIG. 3A shows cellular telephone 110 including a network interface 310 connected to an antenna 320. Network interface 310 can be for example a modem. Activity monitoring unit 130 links between a CPU 330 and network interface 310. CPU 330 is also linked to the user interface (typically although not necessarily in a cellular telephone including a keyboard and a display) represented as block 340. In FIG. 3B, activity-monitoring unit 130 is linked to the BUS 350, linking CPU 330 to network interface 310 and user interface 340. FIG. 3C is similar to FIG. 3B but activity monitoring unit 130 is included within the framework of an independent auxiliary device 360 which is connected to communication device 110. The configurations illustrated in FIGS. 3A, 3B, and 3C are also examples of configurations for communication device 140 (with “110” replaced by “140”).

Activity monitoring unit 130 may be any combination of hardware, software and/or firmware that performs the functions as defined and explained herein. The link between monitoring unit 130 and receiver/transmitter means of the associated communication device 110 or 140, for example network interface 310, allows unit 130 to transmit stored activity data, through the cellular communication infrastructure, to server utility 150, preferably as out-of-band traffic. Preferably, in addition, the link is configured so as to cause all data received by the associated communication device 110 or 140 to be intercepted by monitoring unit 130 prior to becoming available to the user of communication device 110 or 140.

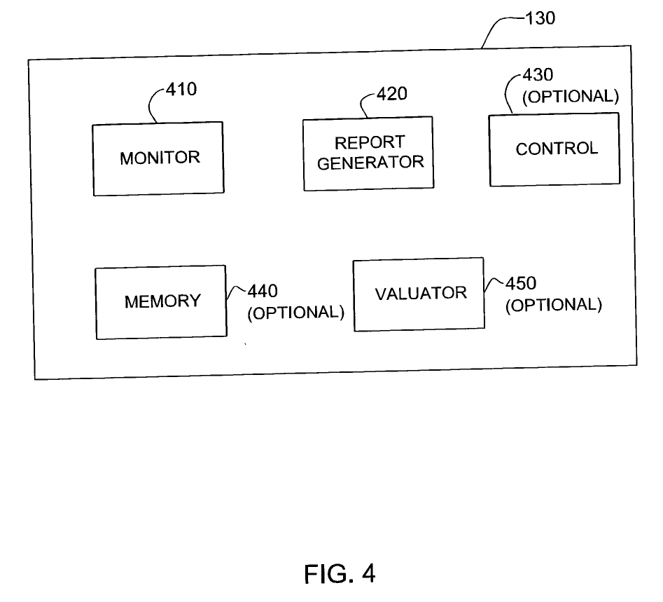

FIG. 4 shows an activity monitoring unit 130, according to a preferred embodiment of the present invention. Monitoring unit 130 includes a monitor 410 for monitoring data activity of the associated communication device 110 or 140, and a report generator 420 for generating reports on the data activity for activity monitoring server utility 150.

Optionally, monitoring unit 130 also includes one or more of the following: a control 430 for exerting control over data activity of the associated communication device 110 or 140 if required, a memory 440 for storing valuation rules and allotment(s) for data activity, and/or a valuator 450 for valuing data activity using the valuation rules and for updating the allotment(s) based on results of the valuation. For example, when required control 430 can block some or all incoming data from reaching user interface 340 and/or some or all outgoing data from reaching network interface 310. Preferably, memory 440 is secure so that contents can not be modified by the user or others, for example in order to change valuation rules or allotment(s). Memory 440 can additionally or instead provide other storage, for example storage of rules for pushed data.

In some cases the valuation of a data activity performed by valuator 350 may equal the rating performed by rating system 220, when checked by rating system 220. However in most cases the valuation uses different rules and therefore does not equal the rating. Preferably the valuation rules are less intricate than the rating (i.e. consider less information about the activity or account). For example, the valuation rules may not take into account activity at other devices 110 or 140 which affects how an activity at a particular device 110 or 140 is rated, may not use as large tables as the rating tables, may not modify the tables as often as rating tables are modified, etc. Preferably, monitoring unit 130 and/or device 110/140 can therefore be less resource-intensive than prior art systems which perform rating in the communication device. Preferably, the valuation does not usually underestimate the cost of an activity compared to the rating performed by rating system 220 for the same activity.

Monitoring unit 130 can also optionally include a data encryption module (not shown). Communication device 110/140 or activity-monitoring unit 130 may also optionally include safety features intended to block the ability to tamper with the device or with the automatic transmission feature, so as to ensure integrity of the activity data transmitted to server utility 150.

As may readily be appreciated by the artisan, the invention is not restricted to any specific system architecture for unit 130, and any system having functions such as these defined and described above, and further below, is within the scope of the invention. For example, while activity unit 130 is illustrated here as being comprised of several modules, in reality, while this may be the case, it is also possible to incorporate the illustrated modules into fewer or more modules. As another example the modules may be separated into more than one monitoring unit associated with the same device 110 or 140, for example with different data activities rated by different units.

The reports generated by report generator 420 and transmitted to mediation system 210 preferably at least include sufficient information which, in conjunction with information otherwise accessible to server utility 150, allows rating system 220 to rate the reported data activity. (Typically although not necessarily, reports are useful for rating purposes and/or for fraud and network management i.e. metering). For example, monitor 410 may be configured to categorize a specific data activity and depending on the category, monitor 410 transfers certain pre-determined information on the activity (i.e. data on the activity) to report generator 420 which is then transferred to server utility 150. Continuing with the example, the categories can be differentiated for example based on one or more of the following: the incorporation or non-incorporation of a price-tag in the data transferred to or from the associated device 110 or 140, whether the data is transmitted or received by device 110/140, the types of communication infrastructure utilized, the source or destination of the data transferred to or from device 110/140, if a web site is accessed then whether the web site charges for access or not, if data is downloaded then whether there is a charge per download, if internal data is used (for example application, multimedia, etc., that optionally may have been previously received via network 120) then whether there is a charge per use, the application on communication device 110/140 using the data, the application protocol (e.g. messaging service protocols, File Transfer Protocol (FTP), Telnet, Simple Mail Transfer Protocol (SMTP), Hyper Text Transport Protocol (HTTP), Simple Network Management Protocol (SNMP), Network News Transport Protocol (NNTP), Audio (MP3, WAV, AIFF), Video (MPEG, AVI, Quicktime, RM), Fax (Class 1, Class 2, Class 2.0), etc), whether or not the data is a response to an earlier request, whether the data is a retransmission of earlier transmitted data, whether data received by device 110/140 was pushed or was requested, the class of service, data utilization, data transmission efficiency, the quality of service, etc. As another example, report generator 420 may be configured to categorize a specific data activity and depending on the activity, generator 420 may include certain pre-determined information out of the information received from monitor 410 in the reports that generator 320 transmits to utility 150. As another example, there may be a pre-determined list of information regarding data activity with each piece of information on the list required or desired by rating system 220 for rating at least one category of data. In this example, activity monitor 410 passes as much information as can be determined for any given data activity to report generator 420 and report generator 420 includes all passed information in reports transmitted to report server utility 150.

Depending on the data activity and the method used by rating system 220 to rate the activity, server utility 150 may require or desire to receive in data activity reports from report generator 420 one or more of the following inter-alia: price-tag information regarding a transaction (for example, service/product identifier field, a merchant identifier field, price information field, product vendor field, and/or category field), time of day, volume of data transferred (e.g. kilobytes, number of packets, etc), volume of data transferred per unit of time, time-interval for data transfer, source and destination of data, distance data traveled, types of communication infrastructure utilized, the application on communication device 110/140 using the data, the application protocol, whether the data is pushed or pulled, if the data is a response to an earlier request, any web sites accessed or only those which charge for access, whether the data is a retransmission of earlier transmitted data (for example so as to avoid charging for a disrupted communication), the class of service, data utilization, data transmission efficiency, the quality of service (for example the actual allocated bandwidth), any downloads or only those for which there is a charge, any uses of data internal to device 110/140 or only those for which there is a charge (for example, if there is a charge per use then the number of times an application such as a game is used, number of times a multimedia such as a song or movie is listened to or viewed, number of times an application or multimedia previously received via network 120 is used/listened to/viewed, etc.), if games were played then which games and how many times and what were the scores, statistical information (for example number of times a particular web site or service was accessed for example which only allows a specific number of accesses, number of similar transactions such as for example buying multi-media data, etc), etc.

It should be evident that different monitoring units 130, even for the same account, can be configured to report different information to server utility 150. For example, a communication device, for example 110 which is capable of only limited data activity may have a simplified monitoring unit 130 which reports a limited number of parameters to server utility 150 compared to a monitoring unit 130 associated with a communication device, for example 140, capable of more extensive data activity.

The transmission of a data activity report from monitoring unit 130 to activity-monitoring server utility 150 is preferably performed automatically in a manner not controlled by the user of communication device 110. This ensures the integrity of activity data transfer to the server utility. Such transmission may be in a communication session initiated by server utility 150, typically although not necessarily at time periods in which the communication infrastructure is less busy, namely at off-peak periods. By another preferred embodiment of the invention, the transmission may periodically be initiated by monitoring unit 130, e.g., automatically after passage of a predefined time or according to a predefined set of rules or alternatively when unit 130 senses an off-peak period. For example in a preferred embodiment with allocations, reports related to an allotment may be transmitted when an allotment reaches the allotment rechecking level (as defined further below), while in another preferred embodiment with allocations, reports related to an allotment may be transmitted any time before an allotment reaches the allotment rechecking level and/or when the level is reached. The exchange of data between unit 130 and server utility 150 may involve standard handshake protocols and will typically although not necessarily be in an encrypted form. The transmission protocols and method of encryption that are used may be such that are known per se and are thus readily available to a person versed in the art.

It should be evident that there is optionally information which is required or desired by rating system 220 for rating data activity which is more efficiently provided by sources other than monitoring unit 130. For example account parameters that can be set by the network operator (with the agreement of the user associated with the account) are preferably stored at server utility 150, for example in database 240. Examples of such parameters include inter-alia: price for usage of communication infrastructure resources (for example price per volume data, price per time-unit of data transfer interval, price per allocated bandwidth, etc), discounts, subscription plans, number of free minutes/amount of free volume, etc. Another example would be a friends and family type program where rating of activity for one account is affected by activity in other account(s), and/or where rating of activity for a communication device 110 or 140 is affected by activity of other communication device(s) 110 or 140 in the same account.

In one preferred embodiment, at least some of the account parameters are arranged in database 240 in the form of rating tables. As it is well known in the art, rating tables are the tables to which an activity is compared and rated accordingly. For example a rating table may state that if a user or some users from a user group (friends and family) used more than 10 MB of information they are entitled to a 10% discount, and if they used more than 20 MB they are entitled to 12% reduction.

A method according to one preferred embodiment of the invention which does not include allotments will now be expanded upon. Because of the lack of allotments, some applications may include safeguards to ensure that allowances do not overstep the restriction levels or that any overstepping is not meaningful prior to the beginning of activity restrictions. Examples of safeguards include inter-alia, monitoring units 130 receiving approval from server utility 150 for any activity, monitoring units 130 receiving approval from server utility 150 for any activity which is expected to cause a large reduction in an allowance (for example assuming an allowance represents an amount of money, a transaction with a price tag above a certain amount), and/or setting the restriction level at an artificially stricter level than required (for example if an allowance represents the remaining credit line, setting the restriction level at an amount above $0), setting an initial allowance cautiously (for example if an allowance represents the remaining credit line, providing a slightly lower initial credit line than supported by the creditworthiness of the user associated with the account), and/or guaranteeing a range or an approximate number for the restriction level rather than an absolute value (for example if the allowance represents the number of traffic updates pushed per hour to communication devices 110 and/or 140 associated with the account, a maximum of between 3 to 5 updates per hour can be guaranteed instead of guaranteeing a maximum of 3 traffic updates per hour with any additional updates blocked).

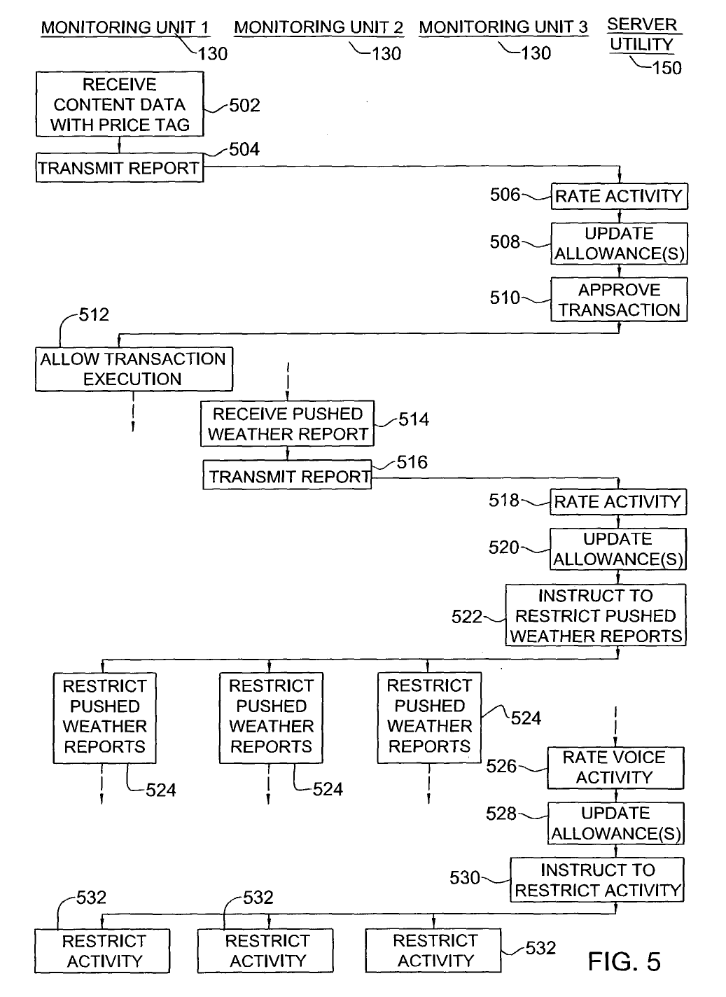

An example of the method according to a preferred embodiment of the present invention is illustrated in FIG. 5. For the sake of illustration, the method will be described for a particular account (details of the account are assumed to be stored in database 240). In the example there are assumed to be three communication devices 110 and 140 associated with the account, for example three wireless devices associated with an account with a cellular operator. It is assumed that each of the communication devices has a monitoring unit 130 (monitoring unit 1, monitoring unit 2, monitoring unit 3), connected or installed within. It is also assumed that transmission of data or conversations among communication devices 110 and 140 is free. The example also assumes two allowances associated with the account, the first allowance being an overall allowance representing the unused credit line for the account (for example currently equaling $50), and the second allowance representing the number of remaining pushed weather reports per day for the account (for example 1 more required). The restriction level for both allowances is assumed to be zero.

In step 502, monitoring unit 1 receives data related to a transaction activity, for example the purchase of content data such as a song. The content data is assumed to have incorporated within a price tag which at least includes the price (for example $30) and a merchant identifier. Monitor 410 passes at least the price and the merchant identifier to report generator 420. A report of the transaction activity is transmitted by report generator 420 to mediation system 210 of server utility 150 in step 504.

It is assumed in this example that all activity with an associated price tag are reported immediately to server utility 150 and that monitoring unit 130 freezes the activity until approval of the price tag is received from server utility 150.

Mediation system 210 transfers the report to rating system 220, preferably after correlating and reformatting the report to a standard known to rating system 220. Rating system 220 rates the activity in step 506. For example rating system 220 can check the account information in database 240 for any discounts applicable to the particular account (which may or may not be applicable to other accounts) which would lower the price compared to the price listed in the price tag. Assuming there are no discounts, rating system 220 rates the activity in accordance with the price tag of $30. Allowance manager 230 receives the result of the rating. In step 508 the allowances are updated. Because the activity did not involve pushed weather reports, the overall allowance for the unused credit line is reduced by $30 and the allowance for weather reports is not changed. Approval of the transaction is transmitted to monitoring unit 1 in step 510 and the transaction is allowed to be executed in step 512.

In step 514 monitoring unit 2 receives a pushed weather report. It is assumed that at least the source of the weather report (typically although not necessarily the weather report service provider) is transferred by monitor 410 to report generator 420 to be included in the report of the activity. It is also assumed that the contract for the weather service reports, does not guarantee an exact number of weather reports (or frequency) but that after an approximate number of reports (or frequency), there will be an attempt to block further weather reports. (Obviously if the all devices 110 and 140 are turned off, the exact number of reports or frequency may also not be able to be reached). For example the contract can be between the user associated with the account, the weather report service provider, and the network operator. Therefore a report of the weather report activity is not necessarily transmitted immediately to mediation system 210 but transmitted aggregated with other reports of activity at monitoring unit 2 (step 516). In step 518, rating system 220 rates the weather report activity. It is assumed that there is a subscription plan for the weather reports whose periodic charge has already been deducted from the allowance for unused credit line. In step 520 the allowances are updated (unused credit line remains unchanged and allowance for weather reports is reduced to zero). Because the allowance for weather reports has reached the associated restriction level, in step 522 server utility 150 informs the three monitoring units 130 to block further weather reports for the rest of the day. For example, memory 410 of each monitoring unit 130 may include rules for pushed data and having been informed, monitoring unit 130 may adapt the rules to read that pushed weather reports are to be blocked, for example by control 430 (step 524).

In step 526, mediation system 210 receives information regarding voice activity and rating system 220 rates the voice activity. Assume that some of the conversations are among the three monitoring units and there is no charge for these conversations in this example. However other conversations include external sources or destinations. Assume the charge for these conversations are calculated based on the length of the calls less any free time multiplied by the rate per unit time and that the total calculated charge for the conversations is $30. The allowances are updated in step 528, with the overall allowance for unused credit now at −$10. Because the restriction level of 0 has been reached (and even overstepped), in step 530 the three monitoring units 130 are told by server utility 150 to restrict activity, for example to only allow free traffic (e.g. toll free web sites) and traffic to the network operator (for example to pay off at least part of the balance due and thereby replenish the allowance representing the unused credit line to an acceptable replenishment level). In step 532, activity is restricted, for example by control 430. If and when the allowance representing the unused credit line is replenished to a predetermined acceptable level, for example by the user associated with the account actively paying off at least part of the balance due, activity can stop being restricted. For example, server utility 150 can inform the three monitoring units 130 to stop restricting activity. When the allowance for weather reports is replenished, for example automatically when the period associated with the number of weather reports expires (i.e. new day), the allowance for weather reports is replenished, and pushed weather reports can stop being blocked. For example, server utility 150 can inform the three monitoring units 130 to stop blocking weather reports. In other preferred embodiments, server utility 150 can cause restriction of activity through network means as described above.

A method according to another preferred embodiment of the invention which includes allotments will now be expanded upon. In order to support the usage of allotments, monitoring unit 130 of communication device 110 (and optionally monitoring unit 130 of communication device 140) includes valuator 450 and memory 410 storing at least valuation rules and allotment(s). In one preferred embodiment, monitor 410 transfers to valuator 450 any information relating to data activity which is required or desired for valuation. Other information required or desired for valuation may be optionally stored in memory 440, for example information which can not be provided or not easily provided by monitor 410. Although one or more allotments may not have associated allotment rechecking levels, and/or limiting levels, preferably at least one allotment has at least one associated allotment rechecking level and limiting level. If an allotment reaches a pre-determined allotment rechecking level, monitoring unit 130 requests an additional allotment allocation. An additional allocation can be requested inherently, for example by report generator 420 sending activity reports to mediation system 210 (i.e. in this example reports are sent only when an additional allocation is desired), or for example by including the current value of an allotment in any reports transmitted by report generator 420 to mediation system 210. Alternatively or in addition, a separate request for an additional allocation can be transmitted by valuator 450 to allowance manager 230. Data activity can continue even though the rechecking level has been reached as long as the allotment has not also reached the predetermined limiting level.

Once the allotment reaches the predetermined limiting level, activity is limited until the allotment is augmented to a predetermined augmentation level. In some cases there may be more than one limiting level for the same allotment. For example, at one limiting level, communication device 110/140 may not begin new data sessions while at a second limiting level, all data activity for communication device 110/140 may be blocked. In some cases the augmentation level can be any amount above the limiting level(s) (or below as the case may be). In other cases the augmentation level may represent for example an amount significantly above the limiting level(s) (or below as the case may be), for example at least equal to the allotment rechecking level if there is a spread between the allotment rechecking and limiting levels. Typically although not necessarily, augmentation of the allotment occurs upon receipt of an additional allocated allotment from utility 150. For a given allowance, server utility 150 can allocate an allotment to monitoring unit 130 which is for example, a function of the remaining allowance (for example a percentage, therefore the size of the allotment varies with the size of the allowance), a function of the initial allowance (for example a percentage, therefore allotment size is constant provided sufficient allowance remaining), any other function, or an absolute value (provided sufficient allowance remains). The predetermined allotment rechecking level can be for example a function of the remaining allotment (for example a percentage, therefore the level varies with the size of the allotment), a function of the initially allocated allotment (for example a percentage, therefore the level is constant), any other function, or an absolute value. Although the allotment rechecking level and limiting level may be identical, there is typically but not necessarily a spread between the two. When the spread between the predetermined allotment rechecking level and the predetermined limiting level is increased, the risk of reaching the predetermined limiting level prior to receiving an additional allotment from utility 150 is reduced. However, the risk of receiving an unnecessary allotment (which may not be needed for additional data activity of the associated communication device but may be needed by other communication devices or for other activities) is at the same time increased. In addition, when the size of the allotment allocated by server utility 150 is increased, the time interval until the next request for additional allotment is reduced (i.e. the frequency of allotment requests is reduced). Therefore increasing the size of the allotment can in some cases reduce the frequency of communications between monitoring unit 130 and utility 150, thereby reducing system overload. However, an increased allotment increases the risk of an unnecessary allotment (which as mentioned above which may not be needed for additional data activity of the associated communication device but may be needed by other communication devices or for other activities). The optimal size for allotment allocation, the optimal values for the allotment rechecking level and limiting level and the optimal spread between the allotment rechecking level and limiting level depend on the application and are not limited herein.

In some preferred embodiments in order to more effectively manage the allocations, server utility 150 can request back some or all of an allocation from one or more monitoring units 130, for example in order to distribute the returned allocations to one or more other monitoring units 130 associated with the account. In some preferred embodiments, a monitoring unit 130 may independently send back some or all of the allotment thereof to server utility 150, for example if the associated communication device is shut off.

It should be evident that in some cases the type(s) of limited activity may have a direct connection with the allotment. For example, if the allotment relates to the number of transmitted emails, then in some cases when the limiting level is reached, only emails may be limited. In other cases there may not be a direct connection between the allotment and the type(s) of limited activity.

Data activity can begin to be limited in one or more of the following ways inter-alia when an allotment reaches a limiting level: blockage of all data activity, blockage of certain types of data activity, blockage of non-free data activity, blockage of some or all non-service related data activity (but allowing some or all service related data activity, for example data activity for replenishing the allowance), preventing all or some new data sessions from beginning (while allowing some or all current data sessions to complete), etc. For example, control 430 can block some or all incoming data from reaching user interface 340 and/or some or all outgoing data from reaching network interface 310. Alternatively, for example blocking can be performed on the network end (as described above)

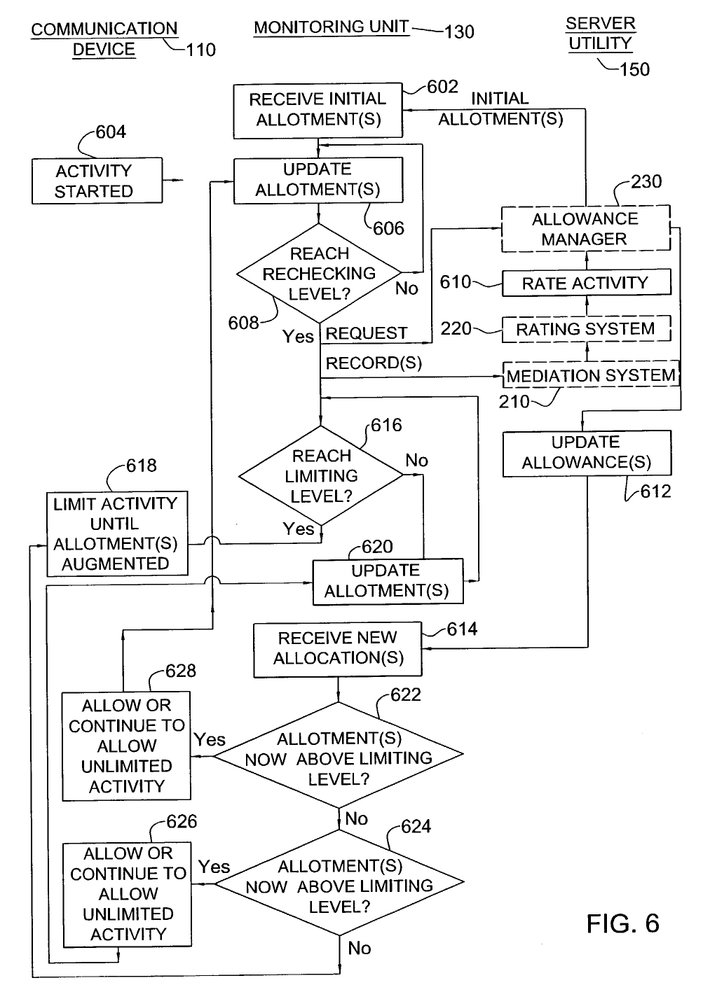

An example of a method including allotments according to a preferred embodiment of the present invention is illustrated by FIG. 6. It is assumed that there are two communication devices 110 and 140, for example two computers associated with a particular account at an Internet Service Provider. For ease of illustration, only one communication device 110 and associated monitoring unit 130 are illustrated in FIG. 6 and the second communication device 140 and associated monitoring unit 130 are referred to only in the text. It is also assumed that there are two allowances associated with the account. The first allowance represents the unused (remaining) prepaid balance, initially for example $1,000. The second allowance represents the number of remaining times a downloaded game can be played for free (for example one more time).

In the example it is assumed that allotments for the first allowance are allowed to be allocated to monitoring units 130 of communication devices 110 and 140 but that no allotment of the second allowance (game-playing) is allowed to be allocated. Therefore the game-playing allowance provides an extra safety margin for the activity rating. An allotment of $100 from the first allowance is allocated initially and then upon request to monitoring units 130 of communication devices 110 and 140. The allotment rechecking level for the unused prepaid balance allotment is assumed to be $50. If the allowance reaches the restriction level, assumed to be $100, (and beyond), activity is restricted by reducing the size of any future allotment to a maximum equal to the remaining allowance.

There are assumed to be two limiting levels for the allotment of the first allowance. At the first limiting level of $2, no new data sessions are allowed whereas at the second limiting level of 0 all data activity is blocked. It is also assumed that the augmentation levels are any amounts above the corresponding limiting levels (i.e. above $0 and above $2) so that if the allotment is augmented above a limiting level, the corresponding limitation is removed.

It is also assumed in this example that valuator 450 of device 110 considers only a limited number of factors when valuing data activity (in order to be able to update the allotment of the unused prepaid balance); for transferred data either the volume of data transferred multiplied by a deliberately high rate per volume of data or the price tag incorporated in the data; for selected internal applications the number of times used multiplied by a deliberately high rate per use. Valuator 450 of device 140 also considers only a limited number of factors when valuing data activity, however valuator 450 also considers for transferred data if the data is a retransmission of earlier transmitted data and only if not, multiplies the volume of data by a deliberately high rate or values the data according to the incorporated price tag.

In step 602, monitoring unit 130 of device 110 receives an initial allocated allotment of the unused prepaid balance from allowance manager 230, in this example $100 (remaining allowance $900). The allotment is stored in memory 440. In step 604, data activity begins for communication device 110. Monitor 410 passes to valuator 450 any factors related to data activity which valuator 450 requires for valuing the activity, for example the volume of data, number of usages, and/or the price tag. The deliberately high rates can be stored for example in memory 440.

Assume for example that the first data activity is web surfing, and that the data has no price tag incorporated. In step 606, valuator 450 values the activity based on the volume of data, for example 10 Mbytes and rate, for example $1/Mbyte, at $10. Valuator 450 therefore updates the allotment to $90. Because the allotment rechecking level is not reached, steps 604 and 606 are repeated for other data activity. For example the next data activity can be game playing with two games played, each game valued at $2.50. Therefore valuator 450 updates the allotment to $85. Continuing with the example, the subsequent data activity can be a transaction which includes a price tag of −$10, i.e. a credit to the account, and therefore valuator 450 updates the allotment to $95. Still continuing with the example, the subsequent data activity can be a purchase transaction which includes a price tag of $50. Valuator 450 therefore updates the allotment to $45.

Because the allotment rechecking level of $50 has been reached (“yes” to question 608), a request for an additional allotment is sent. In this example, it is assumed that reports are sent by report generator 420 to mediation system 210 when the allotment rechecking level is reached. It is also assumed that a separate request for an additional allotment is also transmitted to allowance manager 230.

The reported activities are rated by rating system 220 in step 610. For example, the report on web surfing may include for example inter alia the volume of data transferred (10 Mbytes), the quality of service (high) and time of day (business hours). The report may also include for example a list of web sites accessed. Because the web-surfing occurred during the day and at a high quality of service, assume that rating system 220 would use the highest rate, for example $0.75 per Mbytes. (A table of rates per volume or algorithms for calculating rates per volume for the account can be stored for example in database 240). The charge per volume is then $7.50 Continuing with the example, assume that the total web site access fees is $3.00. (A table of access fees for sites which charge per access or algorithms for calculating the rates can be stored for example in database 240). Therefore the rating for the first activity is $10.50 (slightly higher than the $10 valued by valuator 450)

The report for the second activity may include for example inter alia the application used (for example the name(s) of the game(s) played) and the number of times used (for example number of times each game played). Assume that the first game played is rated at $1.00 and the second game played is rated at $0.50 (A table of rates per application or algorithms for calculating rates per application for the account can be stored for example in database 240). However because one free game remains in the allowance, the charge for the first game is waived. The activity is therefore rated at $0.50.

The report for the third activity includes for example inter alia the price and merchant identifier from the price tag. The credit for the third activity is assumed to be rated at −$10 in accordance with the price tag. The report for the fourth activity includes for example inter alia the price and merchant identifier from the price tag. The actual price for the fourth activity is assumed to be reduced by 10% compared to the price of the price tag due to preference shown by the merchant to accounts with the network operator and is therefore rated at $45. Therefore the total rate for the four activities is $46 (rather than the $55 valuation by the valuator).

In step 612 the first allowance is updated by allowance manager 230 to $909 to account for the $9 difference between the rating result of rating system 220 and the valuation result of valuator 450. The second allowance of free games is updated to zero. As the allocated allotment for the first allowance is assumed in this example to be an absolute value (as long as sufficient allowance remaining), an additional $100 allotment is sent in step 614 to monitoring unit 130 of device 110.

Meanwhile, communication device 110 has continued data activity because the limiting levels of $2 and $0 have not been reached (“no” to question 616) The allotment has been updated to $30 (step 620) due to the additional data activity and with the new $100 allocation received in step 614, the total allotment becomes $130.

It is assumed that one of the times that a request is sent by monitoring unit 130 of communication device 110 for an additional allotment, and data activity continues, the allotment reaches the first limiting level, assumed to be $2 in this example (“yes” to question 616). The allotment may have reached the first limiting level for example, because there was a slowdown in communication between server utility 150 and monitoring unit 130, or as another example because of unexpectedly expensive data activity at communication device 110 such as for example a large purchase transaction or a lot of data activity. Because a limiting level has been reached, monitoring unit 130 limits data activity of device 110, in this example preventing new data sessions from beginning (step 618). It is assumed that the second limiting level of $0 is not reached before the new (non-zero) allotment is received (step 614). The new allotment allocation is received in step 614. When the allotment is received and the allotment to rises above the rechecking level, monitoring unit 130 stops limiting data activity of device 110, for example by again allowing new data sessions (step 623).

It is assumed that at one point, because of the high data activity at device 110 compared to device 140, server utility requests from device 140 to return part of the allotment of device 140, for example $50. The returned part is transferred to server utility 150 and increases the allowance.

Eventually it is assumed that monitoring unit 130 of device 110 is left with an allotment of $50 (“yes” to question 608) and server utility 150 has an allowance of $30 for the associated account. An additional allotment is requested and data reports are sent. Based on the data activity reports, it is assumed that the allowance is adjusted upward to $35 (step 612). Because the restriction level of $100 has been reached, instead of an allotment of $100, only the remaining allowance of $35 is allocated as an allotment to monitoring unit 130 of device 110 in step 614. In the meantime, data activity of device 110 has reduced the allotment to $30 and therefore with the receipt of the additional allocation in step 614, the allotment reaches $65. Activity continues (step 623). When the allotment again reaches the allotment rechecking level of $50 (“yes” to question 608), data activity reports and a request for a new allocation are transmitted. It is assumed that in step 610 rating system 220 rates the reported activity identically as valuator 450 and therefore the allowance remains unchanged at $0 in step 612. Therefore in response to the request for an additional allocation, server utility 150 sends a $0 allotment in step 614 (or sends an alternative indication of no remaining allowance/denial of request for allocation). Activity continues (step 626). With continued activity, the allotment reduces to both the first limiting level (here $2) and the second limiting level (assumed to be 0) (“yes” to question 616) and data activity of device 110 is limited in this example first by preventing new data sessions from beginning (when $2 reached) and then by blocking all activity (when $0 reached) (step 618). For example control 430 can limit the data activity. In a sub-example of this example, because a $0 allotment is received (or allotment denied), communication device 110 is also disconnected. In this sub-example which for the sake of example assumes the TCP/IP protocol, the connection is closed if $0 allotment is received or allotment denied (but the connection kept open and the data only frozen if the limiting level is reached while allowance remains).

Data activity is assumed in this example to only be allowed again if the allotment is augmented above the limiting levels. Typically but not necessarily the augmentation will occur as a result of replenishing the allowance to the predetermined replenishment level. For example, the user associated with the account can purchase additional prepaid balance, replenishing the allowance, and then server utility 150 can allocate at least part of the replenished allowance to monitoring unit 130 of device 110.

It will also be understood that the system according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

While the invention has been described with respect to a limited number of embodiments, it will be appreciated that many variations, modifications and other applications of the invention may be made.

What is claimed is:

1. A method of real time management of a communication network account, comprising:
an activity monitoring unit installed in or connected to a communication device monitoring data activity of said communication device, said communication device associated with the communication network account;
said activity monitoring unit reporting on said monitored data activity to an activity monitoring server utility;
said activity monitoring server utility rating said reported data activity;
based on a result of said rating, said activity monitoring server utility updating at least one allowance of the account; and
if an allowance of the account reaches a pre-determined restriction level, changing the permitted activity for the account.

2. The method of claim 1, wherein the change is immediate.

3. The method of claim 1 or 2, further comprising:
said activity monitoring server utility updating said at least one allowance based on voice activity of said communication device.

4. The method of claim 1 or 2, further comprising:
said activity monitoring server utility updating said at least one allowance based on activity of at least one other communication device also associated with the account.

5. The method of claim 1 or 2, further comprising:
said activity monitoring server utility allocating at least one allotment of at least one of said allowances to said activity monitoring unit; and
said activity monitoring unit performing a valuation of said monitored data activity and updating said at least one allotment based on a result of said valuation.

6. The method of claim 5, wherein said reporting on said monitored data activity included:
said activity monitoring unit requesting an additional allotment when an allotment reaches a predetermined allotment rechecking level.

7. The method of claim 6, wherein said changing the permitted activity includes:
said activity monitoring server utility denying said requesting for said additional allotment.

8. The method of claim 6, wherein said changing the permitted activity includes:
said activity monitoring server utility allocating a smaller additional allotment than previous allocated in response to said requesting.

9. The method of claim 5, further comprising:
if an allotment reaches a predetermined limiting level, limiting data activity of said communication device as long as said allotment is not augmented to a predetermined augmentation level.

10. The method of claim 9, wherein said limiting activity includes:
blocking non-free data to and from said communication device.

11. The method of claim 9, wherein said limiting activity includes:
preventing new data sessions to begin.

12. The method of claim 9, wherein said limiting activity includes:
blocking all data to and from said communication device.

13. The method of claim 9, wherein said limiting activity includes:
blocking at least one predetermined type of data activity by said communication device.

14. The method of claim 9, wherein said limiting activity includes:
blocking non-service related data activity by said communication device.

15. The method of claim 9, wherein said limiting is performed by said activity monitoring unit.

16. The method of claim 5, further comprising:
said activity monitoring unit returning at least part of an allotment to said activity monitoring server utility.

17. The method of claim 1 or 2, wherein said changing the permitted activity includes:
blocking non-free data to and from said communication device as long as said allowance is not replenished to a predetermined replenishment level.

18. The method of claim 1 or 2, wherein said changing the permitted activity includes:
preventing new data sessions for said communication device from beginning as long as said allowance is not replenished to a predetermined replenishment level.

19. The method of claim 1 or 2, wherein said changing the permitted activity includes:
blocking all data to and from said communication device as long as said allowance is not replenished to a predetermined replenishment level.

20. The method of claim 1 or 2, wherein said changing the permitted activity includes:
blocking at least one predetermined type of data activity to and from said communication device as long as said allowance is not replenished to a predetermined replenishment level.

21. The method of claim 1 or 2, wherein said changing the permitted activity includes:
blocking non-service related data activity to and from said communication device as long as said allowance is not replenished to a predetermined replenishment level

22. The method of claim 1 or 2, wherein said changing the permitted is performed by said activity monitoring unit.

23. A system for real time management of a communication network account, comprising:
an activity monitoring unit installed in or connected to a communication device associated with the account, said unit configured to monitor data activity of said communication device and to report on said data activity; and
an activity monitoring server utility configured to receive reports on said data activity from said unit and to rate said data activity, and configured to update at least one allowance of the account based on a result of said rating;
wherein permitted activity for the account is changed if an allowance of the account reaches a predetermined restriction level.

24. The system of claim 23, wherein the change is immediate.

25. The system of claim 23 or 24, wherein said communication device is a wireless communication device.

26. The system of claim 23 or 24, further comprising:
at least one other activity monitoring unit installed in or connected to at least one other communication device associated with the account, said at least one other unit configured to monitor data activity of said at least one other communication device and to report on said data activity;
wherein said utility is also configured to receive reports on said data activity from said at least one other unit, to rate said data activity, and to update said at least one allowance based on a result of said rating.

27. An activity monitoring unit installed in or connected to a communication device, for real time management of a communication network account associated with the communication device, comprising:
a monitor for monitoring data activity of the communication device, and
a report generator for generating reports on said data activity for use by an associated activity monitoring server utility.

28. The activity monitoring unit of claim 27, further comprising:
a control for controlling data activity of the communication device based on a status of the account.

29. The unit of claim 27, further comprising:
a memory for storing valuation rules and at least one allotment for data activity, said at least one allotment received from said associated server utility; and
an valuator for valuing data activity using said valuation rules and updating said at least one allotment based on results of said valuation.

30. An activity monitoring server utility for real time management of a communication network account comprising:
a mediation system for receiving reports on data activity from at least one monitoring unit installed in or connected to at least one communication device associated with the account;
a rating system for rating said data activity;
an allowance manager system for managing at least one allowance of the account;
wherein permitted activity for the account is changed if an allowance of said account reaches a predetermined restriction level.

31. The server utility of claim 30, wherein the change is immediate.

32. The server utility of claim 30 further comprising a database storing account information which is accessible by said rating system and said allowance management system.

33. A computer program product that includes a computer storage medium for storing a computer code portion for executing said monitoring and reporting steps of method claim 1.

34. A computer program product that includes a computer storage medium for storing a computer code portion for executing said rating and updating steps of method claim 1.
